(19) United States
(12) Patent Application Publication
(10) Pub. No.: US 2004/0195181 A1
(43) Pub. Date: Oct. 7, 2004

(54) Water purification system for heating, ventilating and cooling systems and open loop systems

(76) Inventor: Joseph Michael Loftis, Pittsburgh, PA (US)

Correspondence Address: Lara A. Northrop, Pietragallo, Bosick & Gordon, One Oxford Centre, 301 Grant Street, 38th Floor, Pittsburgh, PA, 15219, US

(21) Appl. No.: 10/818,480

(22) Filed: Apr. 5, 2004

Related U.S. Application Data
(60) Provisional application No. 60/553,683, filed on Mar. 16, 2004.
(60) Provisional application No. 60/460,720, filed on Apr. 4, 2003.

(51) Int. Cl. C02F 1/28

(52) U.S. Cl. 210/660; 210/202; 210/282

(57) ABSTRACT

A water treatment and maintenance system using microbiologically pure alkaline water for use as initial fill and subsequent makeup for water based heating ventilating and cooling (HVAC) closed loop systems and for once-through open-end potable hot and cold water storage systems is disclosed. Loop water is treated with an impregnated media filter comprising silver impregnated activated carbon adsorbents and copper impregnated activated carbon adsorbents to maintain bacteriostasis. A water treatment and maintenance system using copper and silver activated carbon adsorbents in a carbon block cartridge is also disclosed.

### CROSS-REFERENCE TO RELATED APPLICATION

This application claims the benefit of U.S. Provisional Patent Application Serial No. 60/460,720 filed Apr. 4, 2003, which is incorporated herein by reference. This application also claims the benefit of U.S. Provisional Patent Application Serial No. 60/553,683 filed Mar. 16, 2004, which is herein incorporated by reference.

### FIELD OF THE INVENTION

The present invention relates to the provision and maintenance of microbiologically pure alkaline water for use as initial fill and subsequent makeup for water-based or water-modulated heating, ventilating and cooling (HVAC) closed loop systems and for once-through open-end potable hot and cold water storage systems.

### BACKGROUND INFORMATION

Microbiologically induced or influenced corrosion (MIC), Legionellae Disease Bacteria (LDB), mold, fungi and other harmful microbiota found in HVAC systems installed in homes, commercial buildings and industry facilities can survive typical water disinfection procedures, such as chlorination. MIC has been known to destroy the entire piping of an HVAC loop, causing significant replacement expense and a complete system shutdown during replacement. Spores from molds such as Alternaria, Cladosprium and Penicillium can trigger respiratory infections, chronic sinus complications and asthma. Memnoniella and Stachybotrys spores can produce mycotoxins that can cause serious breathing problems and flu-like symptoms. Buildings having such harmful microbiota present in HVAC systems are potential candidates for “Sick Building Syndrome” which can cause a significant percentage of the building population to suffer from respiratory difficulties, allergic reactions, itchy eyes and throats and potential nervous system damage.

In most HVAC systems, at least some water evaporation occurs resulting in increased concentrations of dissolved and suspended impurities such as scale, corrosion byproducts and sediment, each of which can contribute to premature piping failure in HVAC systems. It is also well known that biofilms and scale can form in valves, fittings and pipe walls causing a breeding ground for potentially harmful bacterial growth. Organisms present in biofilms, such as certain protozoans, may also shield LDB from biocides. Areas of unused piping, such as dead-legs, can also provide a source of stagnant water, which in turn can provide a breeding ground for bacterial growth.

Traditional methods of controlling MIC, LDB, fungi, mold and other harmful microbiota typically required a system blow-down. In one type of blow-down, a piping loop is taken offline, discharged via a pump system and subsequently refilled. In another type of blow-down, a piping loop remains online while a portion of the loop water is periodically bled-off. These discharge procedures were intended to reduce the concentration of harmful microorganisms and dilute the level of impurities present in the loop piping. While somewhat effective, most HVAC systems also required the addition of various chemicals, biodispersants and/or biocides to attempt to reduce operating problems caused by corrosion, deposition and microbiological growth. During recirculation and blow-down, these chemicals were flushed throughout the piping in an attempt to further reduce the concentration of harmful microbiota.

In light of the high cost of these chemicals, as well as the environmental problems associated with their discharge, a method of maintaining the water quality in closed loop systems that reduces the frequency of system blown down is desirable.

Open loop water storage systems have also been found to harbor LDB and other harmful bacteria and microbiota. Current methods for reducing and managing LDB and other harmful bacteria include introducing copper and silver ions via expensive electrolytical chemical generation methods. In light of the high cost of electrolytic chemical generation methods presently available, a water purification system for use with open loop systems that does not require electrolytically generating copper and silver ions as free radicals is desirable.

The present invention has been developed in view of the foregoing.

### SUMMARY OF THE INVENTION

The present process provides a mechanism for reducing corrosion, microbiological deposition and growth in a water containment system, and maintains continuous bacteriostasis to control MIC, LDB and other harmful aerobic and anaerobic bacteria and microbiota without the need for massive doses of chemical additives, biodispersants or biocides.

It is an aspect of the present invention to provide a system for purifying water, comprising a water containment system and at least one filter comprising an adsorbent including copper and carbon in fluid communication with the water.

It is another aspect of the present invention to provide a cartridge for use with a water containment system comprising an adsorbent including copper and carbon.

It is yet another aspect of the present invention to provide a method of purifying water, comprising providing water in a water containment system and contacting the water with at least one filter comprising an adsorbent including copper and carbon.

These and other aspects of the present invention will be more apparent from the following description.

### BRIEF DESCRIPTION OF THE DRAWINGS

FIG. 1 is a schematic diagram of the purge process in accordance with an embodiment of the present invention.

FIG. 2 is a schematic diagram of the initial fill system process in accordance with an embodiment of the present invention.

FIG. 3 is a schematic drawing of the secondary re-circulation process in accordance with an embodiment of the present invention.

FIG. 4 is a schematic drawing of an open loop system in accordance with an embodiment of the present invention.

FIG. 5 is a drawing of a filter comprising copper impregnated carbon adsorbents in accordance with an embodiment of the present invention.

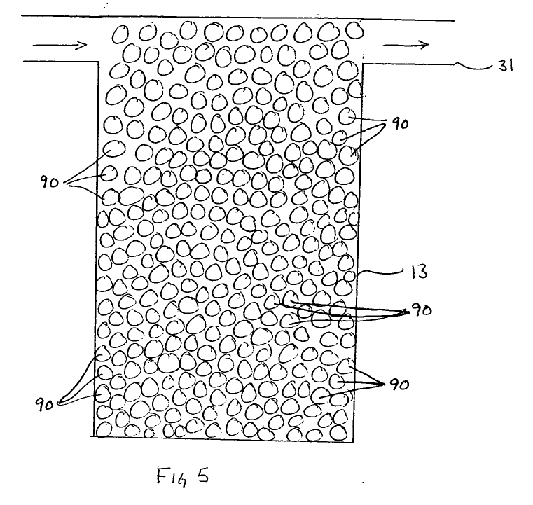

FIG. 6 is a drawing of a filter comprising copper impregnated carbon adsorbents blended with silver impregnated carbon adsorbents in accordance with an embodiment of the present invention.

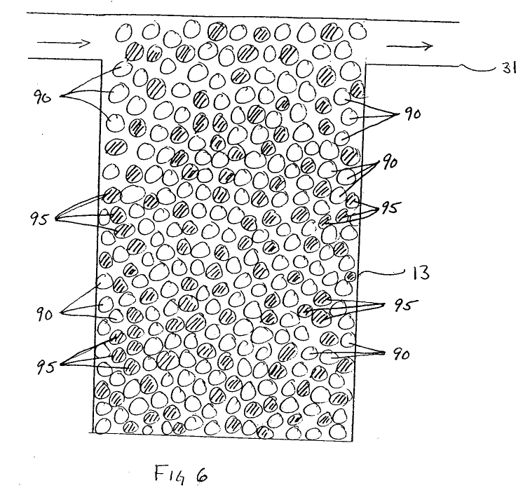

### DETAILED DESCRIPTION

The present invention may be used as a new installation water purification and maintenance system in homes, commercial buildings or industry facilities including on-board or shipboard usage in the marine industry. The present invention may also be used to retrofit an already existing water system. In one embodiment, the closed loop piping requirements for HVAC systems used in apartment complexes, hospitals and other health care facilities, shipboard usage for recreational and freight vessels, yachts, hotels, office buildings, and manufacturing plants are all suitable candidates for the closed loop water purification and maintenance system of the present invention. In another embodiment, the open loop water storage systems used for swimming pools, hot and cold water storage facilities such as for laundry and showers are suitable candidates for the open loop water purification and maintenance system of the present invention.

As used herein, the term “closed loop” means a water transfer system that is entirely enclosed such as by pipes, tanks, valves or other fittings. As used herein, the term “open loop” means a water transfer system comprising at least one area in which a body of water is exposed to air, i.e. unconfined by pipes, tanks, valves or other fittings. As used herein, the term “water containment systems” means a closed loop or open loop system comprising piping and/or water storage tanks.

### The Closed Loop Embodiments

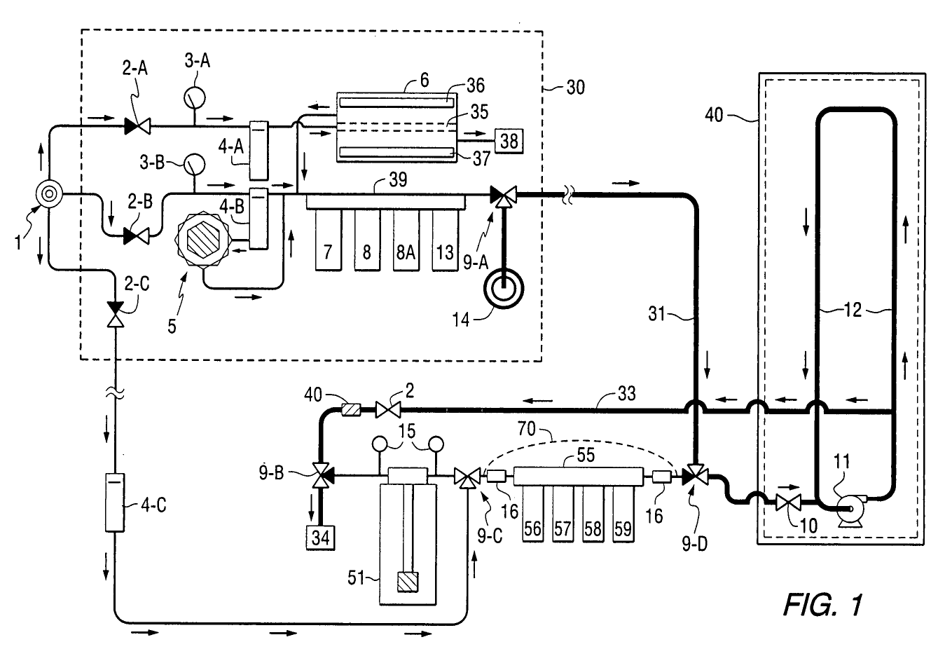

In retrofit applications, an existing closed loop piping system may already be contaminated with high concentrations of MIC, LDB, fungi, mold or other harmful microbiota including sessile slime forming bacteria, such as sulfate reducing bacteria and acid producing bacteria, which form dense sticky biomasses that sustain the growth of other organisms. To clean an already existing contaminated system, a purge process 50 as shown in FIG. 1 can be performed.

The Purge Process

A building 40 having an existing HVAC closed loop water system 12 for supplying the building 40 with loop water typically comprises a network of metal pipes, valves and fittings. Loop water can be used for heating, ventilating and cooling functions of a building 40. To retrofit an existing HVAC loop system 12, a port 10, such as a flow control valve, can be constructed in flow communication with the loop water contained in the loop system 12. In one embodiment, the port 10 is located in near proximity to the existing building pump system 11 which pumps loop water through the loop system 12 of the building 40. Pump systems 11 typically comprise a centrifugal pump or a plurality of centrifugal pumps. Port 10 is connected to a temporary purifying piping system 31 that is connected to a source of biocide 14.

In one embodiment, the biocide is chlorine dioxide, which is particularly effective against bacteria that form biofilms. Chlorine dioxide is a strong chemical agent that is capable of killing bacteria that cause MIC, LDB, fungi, mold and other harmful microbiota thereby disinfecting and sanitizing the piping, valves and other fittings comprising the loop system 12 when introduced into the loop water. Chlorine dioxide does not form HClO in water but rather exists as a gas in solution and is very effective in alkaline pH ranges. Once introduced to the water in the loop system 12, the chlorine dioxide typically exists as a gas in solution until it dissipates or hydrolyzes over a period of time. Other organic biocides or biodispersants can be used to purge the loop system 12, however, chlorine dioxide is preferable because it is equally effective in acid and alkaline environments, it is easy to generate and it does not have to be removed from the loop system 12 because it naturally dissipates over a short period of time without requiring physical or chemical removal procedures after sanitizing the system. Other biocides such as chlorine are not as effective in strong alkaline environments.

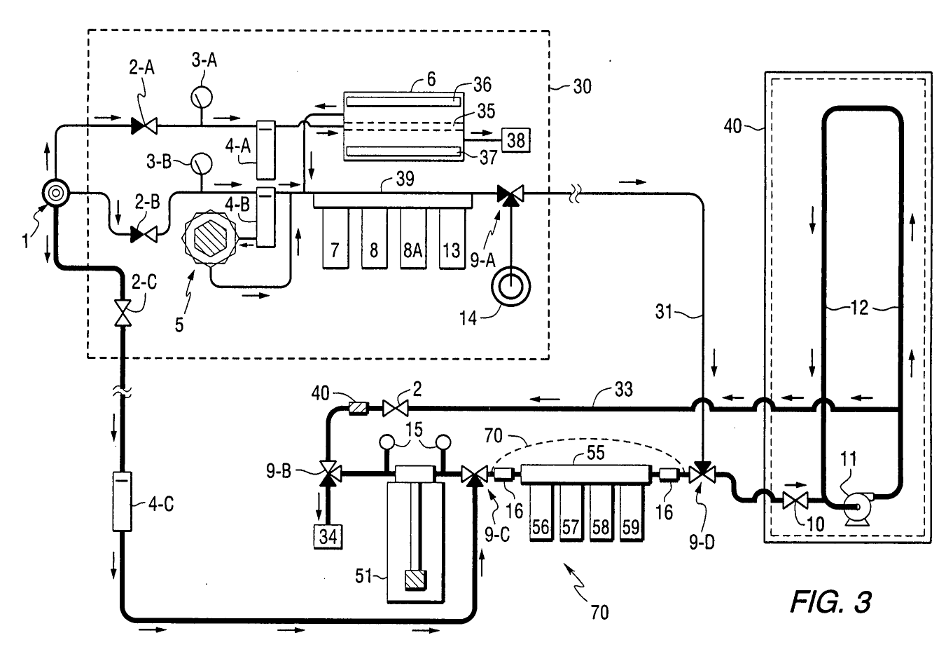

In one embodiment, the source of biocide 14 is a chlorine dioxide generator mounted on a portable skid 30 such as those available from Halox Technologies, Inc or Capital Controls Company. Biocide is passed along temporary purifying piping system 31 and introduced through port 10 into the loop water housed in loop system 12. The existing pump system 11 circulates the biocide throughout the loop system 12 and, optionally a secondary recirculation loop as shown in FIG. 3, without the need for additional pumping requirements. In the event the existing pump system 11 is inadequate for properly circulating the biocide through loop system 12, additional pumping systems can be added.

Biocide is typically added in an amount of from about 2 to about 6 ppm to the total loop water volume present in the loop system 12. Loop system 12 can comprise from about 1,000 to about 6,000 gallons of loop water per loop system 12. In another embodiment, biocide is added in an amount of from about 3 to about 4 ppm to the total loop water volume present in the loop system 12. Temporary purifying piping system 31 may comprise a valve 9A positioned near the source of biocide 14 to control the addition of biocide to the temporary purifying piping system 31. In one embodiment, the valve 9A is a three-way valve. During the purge process, the valve is in flow connection between the source of biocide 14 and the temporary purifying piping system 31 exclusively. Temporary purifying piping system 31 typically comprises any suitable piping material such as stainless steel or PVC/CPVC plastic pipes and fittings.

Once biocide has been introduced into the loop system 12, it is allowed to circulate within the existing piping of the loop system 12 for a sanitization period of from about 30 minutes to about one hour. After the sanitization period, biocides such as chlorine dioxide dissipate or hydrolyze without requiring subsequent removal or purging from the system. Any residual hydrolyzed chlorine dioxide remains in the loop system 12 as a bacteriostatic agent with no harmful effects to the loop system 12 or the water contained therein. In the event a biocide is used that does not dissipate or hydrolyze, a subsequent removal process may be required.

In another embodiment, a non-ionic surfactant, such as ASI 8873 available from Applied Specialties, Inc. is also introduced to the loop system 12 through port 10 along temporary purifying piping system 31. Non-ionic surfactants can be particularly effective in penetrating slime deposits present on the insides of pipe walls, valves and instrumentation ports contained in the loop system 12. In one embodiment, a non-ionic surfactant can be combined with the addition of chlorine dioxide and introduced into loop system 12 simultaneously. In another embodiment, the non-ionic surfactant can be added to the loop system 12 in an amount of from about 2 to about 5 ppm based on the total volume of the loop water present in the loop system 12 prior to the addition of the biocide, such as chlorine dioxide.

Once the loop system 12 is sanitized, the loop water containing the biocide and optionally the non-ionic surfactant, can be optionally purged from the loop system through discharge port 9B. Discharge port 9B can be connected to an optional piping system 33 that is connected to a drainage device 34. In one embodiment, discharge port 9B is accessed after the sanitization period is complete. If a purge is performed, clean water already contacted with a biocide is added to the system and the temporary purifying piping system 31 can be disassembled and removed from the site along with the source of biocide 14.

Depending on the condition of the loop system 12, the water treated with biocide may not require purging. For example, if no significant bacterial incursion has occurred, there would be no need to discharge the water after adding chlorine dioxide gas.

It is herein contemplated that a single closed loop system or a plurality of closed loop systems can be sanitized in this manner. For multiple loop systems that do not share a common water supply, a plurality of temporary purifying piping systems 31 and ports 10, each in flow communication with a different loop system, can be connected to a source of biocide 14. A plurality of temporary discharge piping systems 33 can also be connected to a drain 34.

The Initial Fill System

Loop systems 12 that have been discharged after a purge process as shown in FIG. 1, as well as new or renovated buildings, marine ships, yachts, homes and other industrial facilities having a newly installed loop system 12, must be initially filled with water. Since newly installed loop systems 12 do not normally contain bacteria, fungi, mold or other harmful microbiota, there is generally no need to perform a sanitizing process as described above. However, initial fill water entering a newly installed loop system 12 or a recently purged loop system 12 may be conditioned to ensure proper alkaline non-corrosive conditions and a low or reduced level of bacteria and other microbiota entering the loop system 12.

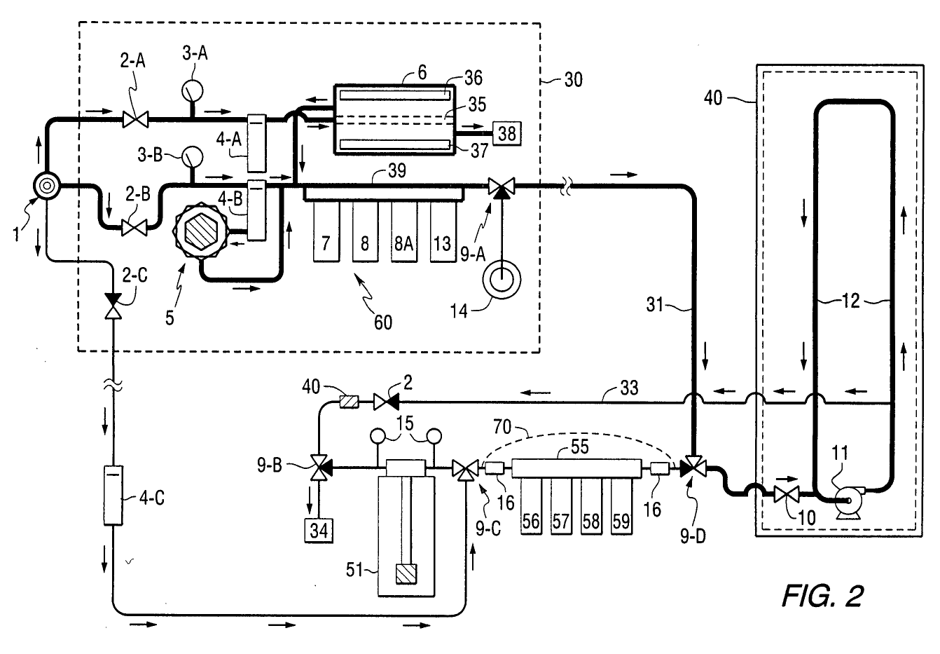

As shown in FIG. 2, an initial fill system for conditioning initial fill water prior to entering loop system 12 is disclosed. Source water 1, comprising treated municipal or treated well water, may be piped through a sediment removal filter 4A-B to remove any suspended solids. Suspended solids present in the source water 1 can provide additional sites for bacteria and other microbiota to attach and grow. Accordingly, it is desirable to remove the solids from the source water 1 before the water enters loop system 12. Ports 2A-B, such as two-way gate valves, and flow meters 3A-B can be used to control the amount of source water 1 entering the sediment removal filters 4A-B at any given time. Sediment removal filters 4 can include bag filters, cartridge filters, sand filters, diatomaceous earth filters, multi-media filters having different strata of various compositions, and the like, that restrain particulate on or within the filter media while allowing water to pass through the filter. The sediment removal filters 4A-B can be back-washable to a drain to remove excess particulate that builds up on or in the filter media. In one embodiment, the sediment removal filters 4A-B remove particulate greater than about 20 microns from the source water 1. Sediment removal filters 4A-B typically have a flow rate of from about one gpm to about five gpm. In one embodiment, a single multimedia sediment removal filter 4 containing layers of different sized particles can be employed. In another embodiment, a plurality of sediment removal filters 4A-B can be used in parallel to decrease the time required to filter the sediment from the source water 1. In yet another embodiment, a plurality of sediment removal filters 4A-B having different size screening capability can be used in series to further reduce the amount of particulate present in the source water 1. For example, source water may pass through a first sediment removal filter 4 comprising a from about a 50 micron to about a 100 micron mesh then subsequently pass through a second sediment removal filter 4 comprising a 20 micron mesh.

Once the source water 1 has passed through the sediment removal filter 4a-b, the effluent is piped to an alkaline inducing device, such as chemical solution-feeding device 5 or water ionizer 6. In one embodiment, the effluent from the sediment removal filter 4A-B is acid neutralized and rendered alkaline within a pH range of from about 8.5 to about 10.5 by adding a pH modifier through a chemical solution-feeding device 5. The chemical solution-feeding device may consist of a chemical mixing tank comprising a drum having a volume of from about 5 gallons to about 55 gallons or larger that is equipped with a mechanical mixing element such as a paddle or a plurality of paddles and a chemical feeding pump or venturi system to add the chemical solution(s) to the water. The pH modifier can be introduced into the chemical solution feeding-device mixing tank 5 simultaneous with, or after water from the sediment removal filter 4A-B has been piped into the tank 5.

In one embodiment, the pH modifier comprises calcium hydroxide, calcium bicarbonate, calcium carbonate, sodium hydroxide, magnesium oxide or combinations thereof. The amount and type of pH modifier to be added to the source water 1 to adjust the pH to from about 8.5 to about 10.5 will vary extensively from one site to another due to the pH and total dissolved solids of source water 1 at each site. A water analysis at each site must be made to determine these criteria.

Mixing elements stir the contents of the chemical solution-mixing tank 5 until the pH modifier is sufficiently dissolved. A heater may be optionally used to assist in the dissolving process. In one embodiment, a pH-sampling unit may be used to determine the pH of the water before it is discharged from the chemical solution-feeding device 5. In another embodiment, the pH may be buffered or maintained by slowly dissolving minerals in the secondary recirculation system as is described herein.

In another embodiment, the pH of the effluent from the sediment removal filter 4a-b can be adjusted by processing the effluent through a water ionizer 6. In this embodiment, water ionizer 6 produces acid and alkaline water by means of an electrolytic process. In order for the electrolytic process to work effectively, the source water 1 must contain a sufficient quantity of dissolved mineral solids. In one embodiment, alkaline mineral solids such as calcium, magnesium, sodium and potassium can be rendered soluble and added to the source water 1 as a pre-treatment step before the source water 1 enters the water ionizer 6. In another embodiment, acid mineral solids such as chlorine, sulfur and phosphorus can be rendered soluble and added during a pre-treatment process. Both alkaline and acid dissolved mineral solids can be added to the source water 1 in pre-treatment processes. In another embodiment of the present invention, a solution of sodium chloride, calcium hydroxide, potassium chloride and/or other solution of dissolved salts may be added to the source water 1. These alkaline and acid dissolved mineral solids must be in true solution, therefore mechanical mixers and/or heaters may be employed to assist in the dissolving process. The amount and type of mineral solids varies depending on the pH and total dissolved solids of the water entering the water ionizer 6. A water analysis is typically performed to determine whether a water ionizer 6 is appropriate and, if so, how much and what type of mineral solids are to be added.

Water ionizer 6 comprises two water chambers, a first chamber 37 having a positively charged electrode and a second chamber 36 having a negatively charged electrode. In this embodiment, source water 1 from the sediment removal filter 4A-B is piped into both chambers of the water ionizer 6. The first chamber 37 is separated from the second chamber 36 by a selective semi-permeable membrane 35. When source water 1 present in the first chamber 37 and the second chamber 36 is subjected to an electric current, disassociated ions are formed according to the reactions shown in Equations 1-3.

2 H20 (liquid)+electric current→2 H2 (gas)+02 (gas) Equation 1:

At the cathode, the source water 1 is converted into hydrogen gas and anions as shown in Equation 2.

4 H20 (liquid)+4 e−(electrons)→2 H2 (gas)+4 OH−(anions) Equation 2:

At the anode, the source water 1 is converted into oxygen gas and cations as shown in Equation 3.

2 H20 (liquid)→02 (gas)+4e−(electrons)+4 H+(cations) Equation 3:

Accordingly, the positive electrode attracts negatively charged mineral ions to the first chamber 37 while the negative electrode attracts positively charged mineral ions to the second chamber 36. The selective semi-permeable membrane 35 allows disassociated mineral ions to pass through the membrane 35 and concentrate according to charge. Once the electrolytic process is complete, the first chamber 37 substantially contains only negatively charged alkaline mineral ions whereas the second chamber 36 substantially contains only positively charged acid mineral ions.

Positively charged ions that are attracted by the negative electrode in the second chamber 36 typically create an alkaline environment and form hydroxides in the source water 1. Excess hydrogen may remain molecular hydrogen or may react to form hydrogen gas, which bubbles out of the water as a gas. For example, a salt solution of sodium chloride disassociates and reacts with water in the second chamber 36 according to Equation 4.

NaCl (salt)+H₂O+elec. current→Na+(ion)+H₂O 2Na+(ion)+2H2O→H₂↑(gas)+2NaOH (base) Equation 4:

Hydrogen gas bubbles out of solution in the alkaline second chamber and NaOH mixes with non-dissociated water molecules to increase the pH of the resulting source water 1 in the second chamber 36.

Negatively charged ions that are attracted by the positive electrode in the first chamber 37 typically create an acid environment and react with water to form oxygen gas and hydrochloric acid. For example, a salt solution of sodium chloride disassociates and reacts with water in the first chamber 37 according to Equation 5.

NaCl (salt)+H₂O+elec. current→Cl−(ion)+H₂O 2C1−(ion)+2H₂O→O₂↑(gas)+2HCl (acid) Equation 5:

Oxygen gas bubbles out of solution in the acid first chamber 37 and HCl mixes with non-dissociated water that is purged to a drain 38.

In one embodiment, the electric current of a commercial alkalizer is applied to the first chamber 37 and second chamber 36. Commercial alkalizers are typically rated for alkalizing water at a constant flow rate of 1 gpm to 5 gpm. At a flow rate of 5 gpm, for example, filling a 1000 gallon closed loop system 12 would take from about 3 hours to about 4 hours to complete the disassociation and ion concentration processes and produce 1000 gallons of alkaline water to fill the entire volume of the loop.

Water contained in the second chamber 36 of the water ionizer 6 is typically increased to an elevated pH. In this embodiment, the elevated pH is from about 8.5 to about 10.5. Acidic environments, such as water having an acidic pH, typically promote chemical corrosion. By alkalizing the pH of the water in the second chamber 36 to a pH of between about 8.5 and about 10.5 prior to introducing this water to the closed loop 12, the alkaline environment significantly reduces and/or retards the development of chemical corrosion in metal pipes, valves and fittings. Typically, highly alkaline water, having a pH of 11 and higher, has negative effects on copper piping.

After the source water 1 has been alkalized in either the chemical solution-feeding device 5 or the second chamber 36 of the water ionizer 6, the alkalized water is piped to a purification chamber consisting of an activated carbon filter 7 in which residual ion impurities, chlorine, organic chemicals, toxic metals and additional particulate can be captured and removed from the source water 1. The carbon filter 7 typically comprises a filter containing a granular activated carbon as available from Calgon Carbon Corporation as one of the components. In one embodiment, the carbon filter 7 employs combined mechanical filtration with physical adsorption of organic chemical contaminants. Carbon filters can be backflushed to remove sediment, silt and other particulate that may be deposited on the filter during filtration. The carbon contained in the filter, however, cannot typically be backflushed to re-open the pores of the carbon. These pores become filled with adsorbed organic materials and can only be partially re-opened via use of superheated steam or thermal regeneration in a furnace such as a rotary kiln. Accordingly, the carbon filters 7 may be periodically replaced or taken offline in order to re-open the filled pores. In one embodiment, a plurality of carbon filters 7 can be employed as stand-alone filtration units or as part of a manifold 39. One or more of the plurality of carbon filters 7 can be removed from the system for cleaning at any time.

Once the water has passed through the carbon filter 7, the water is piped to a synthetic resin media filter 8 to destroy waterborne pathogenic and non-pathogenic bacteria as well as other microbiota. The synthetic resin media filter 8 can be a stand alone filtration complex or it can be incorporated with other filters, including the granular carbon filter 7, as part of a manifold 39.

In one embodiment, the synthetic resin media cartridge 8 comprises an ion exchange resin regenerated with a halogen such as iodine, bromine or chlorine. In the preferred embodiment, the synthetic resin media cartridge 8 comprises positively charged halogen ions such as poly-iodide ions. In yet another embodiment, the synthetic resin media cartridge 8 comprises synthetic tri-iodine and/or synthetic penta-iodine. Positively charged poly-iodide ions, such as tri-iodide or penta-iodide, can be chemically bonded to an anion exchange resin, as manufactured by the Purolite Company, Inc., which is housed within the synthetic resin media filter 8.

In another embodiment, the synthetic resin media cartridge 8 is a poly-iodinated resin that is combined into the hollow core of a paper or spun fiber element sediment filter cartridge which allows for radial intake of fluid. The paper sediment filter cartridge may also comprise a hollow center core for the inclusion of poly-iodinated resin and/or other halogenated materials as discussed above. The paper sediment filter cartridge can be a melamine resin-bonded filter cartridge as manufactured by Superior Adsorbents Inc. The halogenated materials may be packaged as loose granules in said cartridge filter and installed in a suitable housing for source water 101 to pass through in a radial flowpath.

Most waterborne bacteria, fungi, mold, viruses and other microbiota are negatively charged, and are therefore attracted to the positive charge of the poly-iodide ions present in the synthetic resin media filter 8. When the bacteria or other microbiota comes into contact with the halogen poly-ions, such as tri-iodine or penta-iodine, sufficient amounts of halogen ion are released to penetrate the surface of the bacteria or other microbiota, causing it to die.

In one embodiment, a tortuous flow path 8A is provided within the synthetic resin media filter 8 to allow the positively charged halogen poly-ions sufficient contact with the bacteria and other microbiota present in the source water 1. A tortuous flow path may comprise a filter containing rachet rings to promote turbulent flow in which the water cascades and tumbles across a series of semisolid doughnut shaped plastic rings providing a continuous mixing effect. In another embodiment, a tortuous flow path is created by passing the source water 1 through a plurality of synthetic resin media filters 8 to ensure sufficient contact with the halogen poly-ions.

Source water 1 that has passed through the synthetic resin media filters 8 and/or 8A, may contain residual halogen poly-ions, additional bacteria and other microbiota. To remove these impurities, the source water 1 can be passed through an impregnated medium filter 13. In one embodiment, the impregnated medium filter 13 comprises an adsorbent including copper and carbon. The carbon can be provided as activated carbon. The carbon can also be provided in an impregnated granular form having a mesh size of from about 8×30 mesh to about 20×50 mesh. Carbon having a mesh size that is finer than a 20×50 mesh would create a pressure drop as liquid passes through the granules. In another embodiment, carbon having a mesh size of from about 100×200 mesh to about 100×270 mesh could be bonded together in any typical amalgam material and formed into blocks sized for radial flow applications. In one embodiment, the carbon has a particle size of at least 0.05 mm. In another embodiment, the carbon has a particle size of from about 0.05 mm to about 3 mm. The adsorbent including copper and carbon can be a copper impregnated activated carbon adsorbent. The copper can be precipitated in the internal pores of the carbon and also on the external surface of the carbon granules.

The impregnated medium filter 13 can also comprise silver. The adsorbent can comprise silver impregnated activated carbon adsorbents containing from about 1% to about 10% metallic silver that has been washed with a 0.1% solution of potassium iodide to complex the silver onto the media to prevent leaching of the silver ions into the source water 1. The silver can also be precipitated in the internal pores of the carbon and also on the external surface of the carbon granules. In another embodiment, the impregnated medium filter 13 comprises silver impregnated activated carbon adsorbents blended with copper impregnated activated carbon adsorbents. The amount of copper present in the impregnated medium filter 13 allows for a discharge of copper from the impregnated medium filter 13 not to exceed 5 ppm. The amount of silver present in the impregnated medium filter 13 allows for a discharge of silver from the impregnated medium filter 13 not to exceed 100 ppb. The silver-copper-carbon blend can comprise a metallic silver impregnated on granulated activated carbon that is combined or blended with a metallic copper impregnated on the granular activated carbon. The silver impregnated carbon has a toxic effect on bacteria and forms complexes with any residual halogen poly-ions thereby removing them from the water. The copper impregnated carbon is an effective algaecide and has a toxic effect on residual harmful microbiota. Combining the silver impregnated granular carbon and the copper impregnated granular carbon results in an adsorbent material that can be fitted into cartridge housings. An impregnated medium filter 13 comprising the copper impregnated activated carbon and silver impregnated activated carbon material can be solidified in a solid block form does not produce any discernable dust or particulate that can be reintroduced into the water. Furthermore, an impregnated medium filter 13 comprising the silver-copper-carbon material is easy to service and requires minimal interruption of the water treatment process during cleaning or reintroduction of a new impregnated medium filter 13. A strong base anion resin may be used in conjunction with the impregnated medium filter 13 to assist in removing additional halogen Polyiodide ions.

The silver-copper-carbon material present in the impregnated medium filter 13 provides another mechanism to maintain bacteriostasis in the source water 1. In one embodiment, a plurality of impregnated medium filters 13 may be used. In this embodiment, a single impregnated medium filter can be removed from the purification process and replaced without disrupting the treatment process.

The process of piping source water 1 through synthetic resin media filter 8 and/or 8A, and subsequently passing the source water 1 through the impregnated medium filter 13 substantially reduces the bacterial content of the source water and effectively eliminates the presence of MIC without need for addition of organic chemical additives, biodispersants and biocides. Accordingly, this eliminates the resultant chemical waste stream residue, which must be properly disposed of during blow down in accordance with existing federal regulations.

It is contemplated herein that although the initial fill system as shown in FIG. 2, has been described above as having a specific flow path, the order in which the source water 1 contacts the sediment removal filter 4a-b, alkaline inducing device such as the chemical solution-feeding device 5 or the water ionizer 6 and the carbon filter 7 can be interchanged. However, source water 1 must ultimately be piped through the synthetic resin media filter 8 and/or 8A before contacting the impregnated medium filter 13 to obtain the full benefits of both filter systems. Accordingly, an alternate initial fill system 60 flow path could direct source water 1 through the filtration elements 4A-B, 8 and/or 8A, 13, 5 and/or 6, and 7 in another order. However, it is necessary to consider additional sources of contamination of the source water 1 when creating an alternative flow path. For example, contamination could occur in either the chemical mixing tank or the water ionizer.

Once the source water 1 has completed the initial fill system flow path, as shown in FIG. 2, it is in appropriate condition for piping into the loop system 12. In the present embodiment, the effluent of the impregnated medium filter 13 is directed through temporary pipe network 31, through valve port 9-D and enters loop system 12 through valve port 10 to fill loop system 12 to capacity. Pump 11 is then initiated to circulate water through the loop. Valve ports 2, 9-B, 9-C and 9-D are then opened to fill the secondary bypass loop so that it is in communication with main loop 12. Additional source water may then be added to return main loop 12 to capacity if and as required. Once the initial fill system as shown in FIG. 2 is complete and main loop system 12 and secondary loop as shown in FIG. 3 has been filed with conditioned water, the piping system used to transfer the effluent from the silver impregnated medium filter 13 can be disassembled.

In another embodiment, the components of the initial fill system as shown in FIG. 2, including the sediment removal filter 4a-b, the alkaline inducing device such as the chemical solution-feeding device 5 or the water ionizer 6, the synthetic resin media filter 8, the impregnated medium filter 13 and/or the carbon filter 7 are housed on a moveable device such as a skid. Once the initial fill system as shown in FIG. 2 is complete and the conditioned water is supplied to the loop system 12, the moveable skid can be driven offsite.

The Secondary Re-circulation System

Once the loop system 12 of a building has been filled with conditioned water following the initial fill system as shown in FIG. 2, periodic maintenance of the loop system 12 is required to ensure the system does not develop bacterial growth or an insurgence of microbiota due to typical operational procedures, piping maintenance or leaks. In some instances, the source water 1 may be sufficiently pure such that the water does not need to be conditioned via the initial fill system as shown in FIG. 2. This can be achieved by opening valve 9C and allowing source water 1 to flow through bypass 70. However, once the source water 1 has been introduced into the loop system 12 of a building 40, whether the source water 1 was treated by the initial fill system shown in FIG. 2 or not, a re-conditioning process is necessary to maintain the alkalinity and bacterial content of the water in the loop system 12.

As shown in FIG. 3, a secondary re-circulation system is used as preventative maintenance for the water contained in the loop system 12. A secondary recirculation system is common to almost all HVAC closed loop systems and is traditionally used to add chemicals, biodispersants and/or biocides. Many existing secondary recirculation pipes can be retrofit to include the embodiments of the present invention. In one embodiment, the secondary recirculation system as shown in FIG. 3 is used to continuously bleed off a portion of the loop water via port 9B. The water bled off from loop system 12 is treated to maintain alkalinity and bacteriostasis and is subsequently reintroduced back to the loop system 12. In one embodiment, from about 5 to about 25 percent of the total volume of water present in the loop system is bled off to the secondary recirculation system as shown in FIG. 3. In another embodiment, from about 1 to about 15 percent of the total volume of the water present in the loop system is bled off to the secondary recirculation system.

Piping system 33 can comprise a series of valves 2 in flow communication with a series of sampling ports 40. In one embodiment, the sampling port 40 can comprise a metallic coupon capable of providing corrosion analysis information. In another embodiment, the sampling port 40 can comprise a sensor, such as a correator which is capable of monitoring the level of chemical corrosion present in the water from the loop system 12. In another embodiment, sample port 40 can comprise a device for evaluating bacterial content of the water. Sampling ports 40 can be connected to a drain 34 for the purpose of discarding sample specimens. Piping system 33 can be connected to a back flushable sand filter or multi-media particulate filter 51 which continuously reduces and removes particulate such as suspended solids, sludge, galvanic corrosion and other corrosion by-products from the loop water.

In one embodiment, the sand filter 51 removes particulate having a particle size of greater than about 20 microns. In another embodiment, a plurality of sand filters 51 can be used to filter the water traveling through piping system 33. Sediment and other particulate captured on or in sand filter 51 can be back flushed to a drain 34. When a plurality of sand filters 51 are used, it is possible to take one filter 51 offline for back flushing and/or servicing while another sand filter 51 remains operational thereby improving efficiency of the secondary re-circulation system as shown in FIG. 3. In another embodiment, a replaceable cartridge particulate filter can be used in place of or in conjunction with the sand filter 51 to accomplish the same particulate removal. In yet another embodiment, a multi-media filter 51 containing filtering materials of differing sizes and densities can be employed for this purpose.

In some instances, a build up of particulate can create an increase in the pressure build-up across the bed of the filter 51. When pressure is increased, the filter 51 can be backwashed by introducing source water 1 through sediment removal filter cartridge 4c and passing water up-flow through the filter 51 to flush sediment particulate matter to drain. During this process the secondary re-circulation system as shown in FIG. 3 may be temporarily shut down. In another embodiment, a bypass can be introduced to keep the secondary re-circulation system operational.

Once the water passes through the sand filter 51 and/or sediment removal filter 4C, it is then piped to a post filtration manifold cartridge filter system 55. In one embodiment, where there is no evidence of bacterial contamination and limited particulate matter in either preexisting loop water or in available treated source water FIG. 1, source water 1 from FIG. 1 may be directly introduced as fresh water or make-up water to the loop system through two-way valve 2-C, filter 4-C, and three-way valve 9-C and processed directly through manifold 55 for alkalization and sanitization. In this and other preceding embodiments, water entering the manifold cartridge system 55 is piped to a first cartridge 56 comprising calcium carbonate. Water passing through the first cartridge 56 is then piped to a second cartridge 57 comprising magnesium oxide. Calcium carbonate present in the first cartridge 56 and magnesium oxide present in the second cartridge buffer the pH of the recirculating loop water by slowly dissolving these alkaline minerals in the water. In one embodiment, the duration of time the water spends in the first cartridge 56 and the second cartridge 57 is determined by the flow rate of the water entering the first cartridge. Typically, the flow rate through either the first cartridge 56 or the second cartridge 57 is from about 0.5 gpm to about 2 gpm. The pH of the effluent of the second cartridge is typically from about 8.5 to about 10.5.

The order of the first and second cartridges 56 and 57 is not critical, and it is herein contemplated that water may be passed through a magnesium oxide containing cartridge prior to contacting a calcium carbonate containing cartridge. In another embodiment, water is piped to a single multimedia cartridge comprising both calcium carbonate and magnesium oxide. Both calcium carbonate and magnesium oxide can cause the loop water to exhibit non-corrosive behavior.

Optionally, effluent from the second cartridge 57 can be piped to a third cartridge 58 comprising calcium hydroxide to further control the pH of the second cartridge 57 effluent. Each of the first, second and third cartridges 56, 57 and 58 can be used to neutralize the acidity of the water, provide a non-corrosive water and adjust the pH. In another embodiment, any of the first, second and third cartridges 56, 57 and 58 can restore the pH of the water to from about 8.5 to about 10.5. In yet another embodiment, calcium hydroxide can be combined with calcium carbonate and/or magnesium oxide in a single multi-media cartridge.

After water exits the first, second and third filters, it is piped to a fourth cartridge 59 comprising an impregnated medium filter. As described above, the impregnated medium filter can comprise an adsorbent including copper and carbon. In another embodiment, the adsorbent is a copper impregnated carbon adsorbent. In yet another embodiment, the adsorbent can also include silver. In another embodiment, the adsorbent can comprise a copper impregnated carbon blended with a silver impregnated carbon. In another embodiment, the impregnated medium filter comprises metallic silver impregnated on granulated activated carbon combined or blended with copper impregnated on the granular activated carbon. In another embodiment, a strong base anion resin may be used in conjunction with the impregnated medium filter to assist in removing additional halogen polyiodide ions.

The manifold cartridge filter system 55 comprises a removable headpiece or access port to allow the addition and removal of media contained in the four cartridges 56, 57, 58 and 59. Suitable shutoff valves, pressure gages, metallic test coupons, meters, probes, electrodes, and the like can be added to the secondary re-circulation system as shown in FIG. 3 to detect conditions which require automatic or manual back flushing filter 51 to remove suspended solids, sludge and other corrosion byproducts, and to monitor corrosion activity within the system which may require replacement of the filter media in the rechargeable cartridges 56, 57, 58 and 59.

It is herein contemplated that the order of the first, second, third and fourth cartridges 56, 57, 58 and 59 can be interchangeable. Thus, in one embodiment, water is passed through the impregnated medium filter 59 before it is piped to the cartridges housing the calcium carbonate 56, magnesium oxide 57 or calcium hydroxide 58.

Water exiting the final cartridge 56, 57, 58 or 59 in the manifold cartridge system 55 is subsequently returned to the loop system 12 through port(s), such as ports 9-D and 10.

### The Open Loop Embodiments

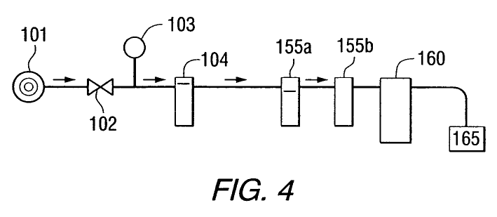

As shown in FIG. 4, source water 101, comprising treated municipal or well water, can be processed for open loop domestic, commercial and industrial applications such as cold water storage/surge tanks and hot water heater tanks. Source water 101 is processed through a backflushable sediment removal filter 104, followed by a cartridge particulate filter 155 as described above, to remove debris such as sand, dirt and various other particles. Valves 102 and flow meters 103, as described above, may be used to monitor and control the amount of source water 101 entering the sediment removal filter 104 at any given time. In one embodiment, the combination backflushable sediment and cartridge particulate removal filter 104 removes particulate greater than about 20 microns from the source water 101.

Effluent from the sediment removal filter 104 is then piped to a cartridge filter 155 containing silver impregnated activated carbon adsorbents and copper impregnated activated carbon adsorbents. In one embodiment, carbon adsorbents are impregnated with silver and/or copper metal salts. This adsorbent contains metals having special oligodynamic properties necessary to control algae, LDB and other potentially harmful microbiota. Copper ions are effective for inhibiting the growth of algae and silver ions are effective bacteriocides or bacteriostats. Carbon adsorbents comprising copper and silver ions are preferable for open loop embodiments because the adsorbent releases copper and silver ions that do not exceed the specifications established by the EPA for potable drinking water. As explained above, most harmful bacteria, fungi, mold and other microbiota are negatively charged and are drawn to the positively charged silver and copper metallic ions, which are maintained on the adsorbents housed in cartridge filter 155.

In one embodiment, cartridge filter 155a contains copper impregnated activated carbon adsorbents and a second cartridge filter 155b contain silver impregnated activated carbon adsorbents. Effluent from one cartridge filter 155a is piped to the second cartridge filter 155b. In another embodiment, the copper and silver activated carbon adsorbents are combined together into a carbon block cartridge filter thereby allowing radial intake of the source water 101 into the cartridge filter 155. Carbon block cartridge filters allow radial flow through the filters, and reduce the amount of carbon fines or dust that can enter the water following contact with the silver and copper adsorbents. In addition, radial intake allows the source water 101 increased contact with the silver and copper carbon adsorbents in the cartridge filter 155, thereby increasing the exposure of the negative sites of harmful bacteria to the positively charged silver and copper metallic ions. In yet another embodiment, a backwashable filter containing silver impregnated and copper impregnated carbon adsorbents, either layered separately or blended together, can be utilized.

In one embodiment of the present invention, the silver and copper carbon adsorbents are produced as granular materials having a sieve screen size of from about 4×8 mesh to about 50×100 mesh or finer. Adsorbents having a fine mesh have an increased reaction rate when the positive ions come into contact with the negative sites of harmful bacteria. Accordingly, adsorbents having a sieve screen size of about 50×100 have an increased reaction rate as compared to adsorbents having a sieve screen size of about 4×8. According to standard adsorption theory, the rate of reaction (R) is inversely proportional to the square of the diameter of the particle size of the adsorbent (d) as set forth in Equation 6.

R=1/d² Equation 6.

In another embodiment, the cartridge filter 155 is a carbon block cartridge containing copper and silver activated carbon adsorbents. The carbon block cartridge 155 containing copper and silver activated carbon adsorbents can be installed into a cartridge housing for use on open-loop re-circulating water systems such as in swimming pools, hot tubs and spas. Care must be taken, however, to ensure discolorization of the liner does not occur due to the photosynthetic reaction that can occur between silver residue and sunlight.

In yet another embodiment, the carbon block cartridge 155 can be combined into the hollow core of a paper or spun fiber element sediment filter cartridge which allows for radial intake. The paper sediment filter cartridge also comprises a hollow center core for the inclusion of loose granules or bonded carbon adsorbent materials. The paper sediment filter cartridge can be a melamine resin-bonded filter cartridge as manufactured by Superior Adsorbents Inc. The silver and copper impregnated active carbon adsorbents may be packaged as loose granules in a cartridge filter and installed in a suitable housing for source water 101 to pass therethrough. The silver and copper impregnated active carbon adsorbents may also be solidified into a carbon block. When solidified into a carbon block, the adsorbent looses about 15% capacity, however, it produces no dust that can be desirable in certain circumstances.

Once the source water 101 has been filtered and conditioned by the cartridge filter 155 to be hostile to waterborne LDB and other pathogenic bacteria and microbiota, the conditioned source water 101 can be introduced into water storage tanks 160 such as cold water storage/surge tanks and hot water heater tanks, used and subsequently supplied to a drain 165. Residual copper and silver ions present in the source water 101 resulting from the silver and copper impregnated active carbon adsorbents, are within the guidelines as presently promulgated by the EPA for potable water requirements.

Whereas particular embodiments of this invention have been described above for purposes of illustration, it will be evident to those skilled in the art that numerous variations of the details of the present invention may be made without departing from the invention as defined in the appended claims.

What is claimed is:

1. A system for purifying water, comprising:
a water containment system capable of housing at least some water; and
at least one filter comprising an adsorbent including copper and carbon in fluid communication with the water.

2. The system of claim 1, wherein the carbon comprises activated carbon.

3. The system of claim 1, wherein the carbon is in particulate form.

4. The system of claim 1, wherein the carbon is coated with the copper.

5. The system of claim 1, wherein the carbon and the copper are bonded to each other.

6. The system of claim 1, wherein the adsorbent comprises copper impregnated activated carbon that has been washed with a solution of copper sulfate.

7. The system of claim 1, wherein the adsorbent further comprises silver.

8. The system of claim 1, wherein the filter comprises silver impregnated activated carbon adsorbent blended with copper impregnated activated carbon adsorbent.

9. The system of claim 7, wherein the filter comprises from about 1 weight percent to about 10 weight percent metallic silver that has been washed with a 0.1 percent solution of potassium iodide.

10. The system according to claim 7, further comprising a plurality of filters comprising silver impregnated activated carbon adsorbent materials and copper impregnated activated carbon adsorbent materials.

11. The system of claim 1, wherein the filter is combined into a hollow core of a sediment filter cartridge.

12. The system of claim 1, wherein the water containment system is a closed loop system.

13. The system of claim 12, wherein the closed loop system is an HVAC loop system.

14. The system of claim 1, wherein the water containment system is an open loop system.

15. The system of claim 1, wherein the filter is housed on a moveable skid.

16. The system of claim 1, further comprising at least one alkaline inducing device in fluid communication with the water.

17. The system of claim 16 wherein the alkaline inducing device renders the pH of the water to be from about 8.5 to about 10.5.

18. The system of claim 16, wherein the alkaline inducing device comprises a chemical solution-mixing tank comprising a pH modifier.

19. The system of claim 18, wherein the pH modifier comprises calcium hydroxide, calcium bicarbonate, sodium hydroxide and/or magnesium oxide.

20. The system of claim 16, wherein the alkaline inducing device comprises a water ionizer.

21. The system of claim 1, further comprising at least one synthetic resin media cartridge in fluid communication with the water.

22. The system of claim 21, wherein the water contacts the synthetic resin media cartridge prior to contacting the filter comprising silver impregnated activated carbon adsorbents and copper impregnated activated carbon adsorbents.

23. The system of claim 21, wherein the synthetic resin media cartridge comprises positively charged halogen ions.

24. The system of claim 21, wherein the synthetic resin media cartridge comprises synthetic tri-iodine and/or synthetic penta-iodine.

25. The system of claim 1, further comprising a sediment removal filter in fluid communication with the water containment system.

26. The system of claim 25, wherein the sediment removal filter is capable of removing sediment having a particle size greater than about 20 microns from the water.

27. The system of claim 1, further comprising a chlorine dioxide generator in fluid communication with the water containment system.

28. The system of claim 1, further comprising a carbon block filter in fluid communication with the water containment system.

29. The system of claim 8, wherein the filter comprising silver impregnated activated carbon adsorbents and copper impregnated activated carbon adsorbents is part of a secondary recirculation system.

30. The system of claim 29, further comprising a manifold cartridge system comprising at least some calcium carbonate, magnesium oxide and/or calcium hydroxide in fluid communication with the secondary recirculation system.

31. A cartridge for use with a water containment system, comprising an adsorbent including copper and carbon.

32. The cartridge of claim 31, wherein the adsorbent further comprises silver.

33. The cartridge of claim 32, wherein the adsorbent comprises silver impregnated activated carbon blended with copper impregnated activated carbon.

34. A method of purifying water, comprising:
providing water in a water containment system; and
contacting the water with at least one filter comprising an adsorbent including copper and carbon.

35. The method of claim 34, wherein the adsorbent further includes silver.

36. The method of claim 34, wherein the water containment system is a closed loop system.

37. The method of claim 34, wherein the water containment system is an open loop system.
